(19) United States
(12) Patent Application Publication
(10) Pub. No.: US 2025/0192814 A1
(43) Pub. Date: Jun. 12, 2025

(54) NESTED STANDS FOR MOBILE DEVICES

(71) Applicant: Urban Armor Gear, LLC, Laguna Niguel, CA (US)

(72) Inventors: Eric Yoshinari, Laguna Niguel, CA (US); Evan Hong, Murrieta, CA (US)

(21) Appl. No.: 18/531,260

(22) Filed: Dec. 6, 2023

(51) Int. Cl. H04B 1/3888; H04B 1/3877

(52) U.S. Cl. CPC H04B 1/3888; H04B 1/3877

(57) ABSTRACT

Nested stands for mobile devices are disclosed. A tablet case includes a body and a stand. The body includes a back wall. The stand includes a base rotatably coupled to a back side of the back wall about a first axis. The stand includes leg(s) hingedly coupled to the base and configured to rotate about a second axis between a closed position, a first extended position, and a second extended position. The leg(s) are configured to be nested with the base in a collapsed configuration when the leg(s) are in the closed position. The leg(s) are configured to support the body in a portrait configuration when the leg(s) are in the first extended position. The leg(s) are configured to support the body in a landscape configuration when the leg(s) are in the second extended position.

### TECHNICAL FIELD

The present disclosure generally relates to mobile devices and, more specifically, nested stands for mobile devices.

### BACKGROUND

Mobile devices, such as smartphones and tablets, have become ubiquitous. Oftentimes, mobile devices are rectangular shaped and may display images in both a landscape view and a portrait view. Many mobile devices also include a camera to capture image(s) and/or video in a landscape view or a portrait view. Further, in some instances, mobile devices include software that automatically transitions between a landscape view and a portrait view as the user rotates the mobile device between a landscape orientation and a portrait orientation.

Mobile devices are typically relatively small. In turn, a user is able to hold a mobile device in a single hand while viewing images displayed on a screen of the mobile device and/or while capturing image(s) and/or video via a camera of the mobile device. However, in some instances, a user may want be able to use the screen and/or camera without having to hold the mobile device in their hand.

### SUMMARY

The appended claims define this application. The present document discloses aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for nested stands for mobile device cases.

An example tablet case disclosed herein includes a body including a back wall and a plurality of a side walls. The back wall includes a front side and a back side. The front side of the back wall and the plurality of side walls define an opening in which a tablet is configured to be securely housed. The tablet case includes a stand. The stand includes a base rotatably coupled to the back side of the back wall about a first axis. The stand includes one or more legs hingedly coupled to the base and configured to rotate about a second axis between a closed position, a first extended position, and a second extended position. The one or more legs are configured to be nested with the base in a collapsed configuration when the one or more legs are in the closed position. The one or more legs are configured to support the body in a portrait configuration when the one or more legs are in the first extended position. The one or more legs are configured to support the body in a landscape configuration when the one or more legs are in the second extended position.

An example stand for a mobile device is disclosed herein. The stand includes a base configured to be adjustably coupled to a back side of the mobile device. The stand includes a leg having a proximal end and a distal end. The proximal end is hingedly coupled to the base and configured to rotate about a first axis. The stand includes a foot hingedly coupled to the distal end of the leg and configured to rotate about a second axis. The leg is configured to rotate about the first axis and the foot is configured to rotate about the second axis to transition the stand between a collapsed configuration, a ring-grip configuration, a portrait configuration, and a landscape configuration. The base, the leg, and the foot are configured to nest together in the collapsed configuration.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a front, perspective view of an example case for a tablet with a stand in accordance with the teachings herein.

FIG. 2 is a front, perspective view of the case of FIG. 1 housing a tablet.

FIG. 3 is a front view of the case of FIG. 1.

FIG. 4 is a front view of the case of FIG. 1 housing the tablet of FIG. 2.

FIG. 5 is a rear, perspective view of the case of FIG. 1.

FIG. 6 is a rear, perspective view of the case of FIG. 1 housing the tablet of FIG. 2.

FIG. 7 is a rear view of the case of FIG. 1.

FIG. 8 is a rear view of the case of FIG. 1 housing the tablet of FIG. 2.

FIG. 9 depicts the case of FIG. 1 with the stand in a portrait configuration.

FIG. 10 is depicts the case of FIG. 1 housing the tablet of FIG. 2 and the stand in the portrait configuration of FIG. 9.

FIG. 11 depicts the case of FIG. 1 with the stand of FIG. 9 in a landscape configuration.

FIG. 12 is depicts the case of FIG. 1 housing the tablet of FIG. 2 and the stand in the landscape configuration of FIG. 11.

FIG. 13 depicts a stand for a smartphone in accordance with the teachings herein in a collapsed configuration.

FIG. 14 depicts the stand of FIG. 13 in an uncollapsed configuration.

FIG. 15 depicts the stand of FIG. 13 secured to a smartphone and in a ring-grip configuration.

FIG. 16 depicts the stand of FIG. 13 secured to a smartphone and in a portrait configuration.

FIG. 17 depicts the stand of FIG. 13 secured to a smartphone and in a landscape configuration.

### DETAILED DESCRIPTION

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Example stands disclosed herein are configured to securely house and/or couple to mobile devices (e.g., tablets, smartphones, etc.). Each of the versatile stands disclosed herein is configured to securely position a respective mobile device in various orientations, such as a landscape orientation and a portrait orientation, without interfering with handheld use of the mobile device.

Each of the stands disclosed herein includes a base that is configured to rotate relative to the respective mobile device to transition the base between a portrait configuration and a landscape configuration. A leg and/or foot is hingedly coupled to the base. The leg and/or foot is rotated to extend away from the base to prop up the mobile in the landscape orientation and/or the portrait orientation. The leg and/or foot is rotated to be concentrically nested with the base in a collapsed configuration that may facilitate a user in holding the mobile device in a handheld manner and/or in easily stowing away the mobile device when not in use.

In some examples, the stand is part of case for a tablet and/or other larger mobile device. In some such examples, the stand includes a leg. The leg includes a proximal end that is hingedly coupled to the base and a distal end that is configured to engage a surface to prop up the mobile device in the landscape and portrait configurations. Further, in some such examples, the stand may include a hand strap that is configured to facilitate a user in more easily and securely holding the mobile device in a handheld manner.

In other examples, the stand is configured to be secured directly to a back side of a smartphone and/or other smaller mobile device. In some such examples, the stand includes a leg that is hingedly coupled to the base and a foot that is hingedly coupled to the leg. The foot includes a distal end that is configured to engage a surface to prop up the mobile device in the landscape and portrait configurations. Further, in some such examples, the stand may be arranged in grip configuration to facilitate a user in more easily and securely holding the mobile device in a handheld manner.

In some examples, the base and the leg or foot is shaped as an even-sided polygon, such as a hexagon. In such examples, each edge of a rectangular-shaped mobile device is to be parallel with a respective edge of the even-sided polygon of the stand when the stand is in the portrait configuration, the landscape configuration, and/or other configurations. For example, the hinged connection of the leg or foot extends along a proximal edge of the even-sided polygon to provide a visual cue that facilitates a user in orienting the base relative to the mobile device for each configuration of the stand. The opposing distal edge of the of the even-sided polygon of the leg or foot is then aligned with the surface that it engages to securely prop up the mobile device in the landscape and/or portrait configurations.

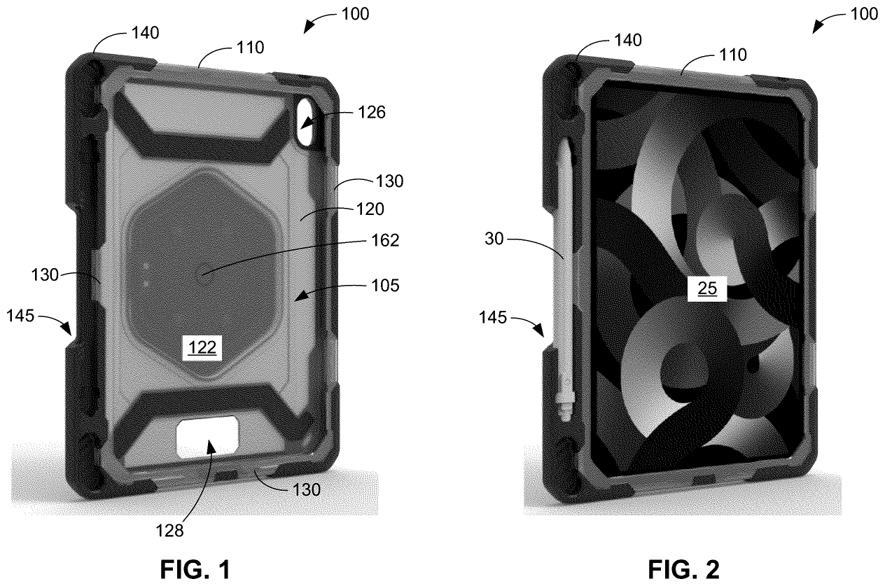

Turning to the figures, FIGS. 1-12 depict an example case 100 for a tablet 25 and/or other mobile device in accordance with the teachings herein.

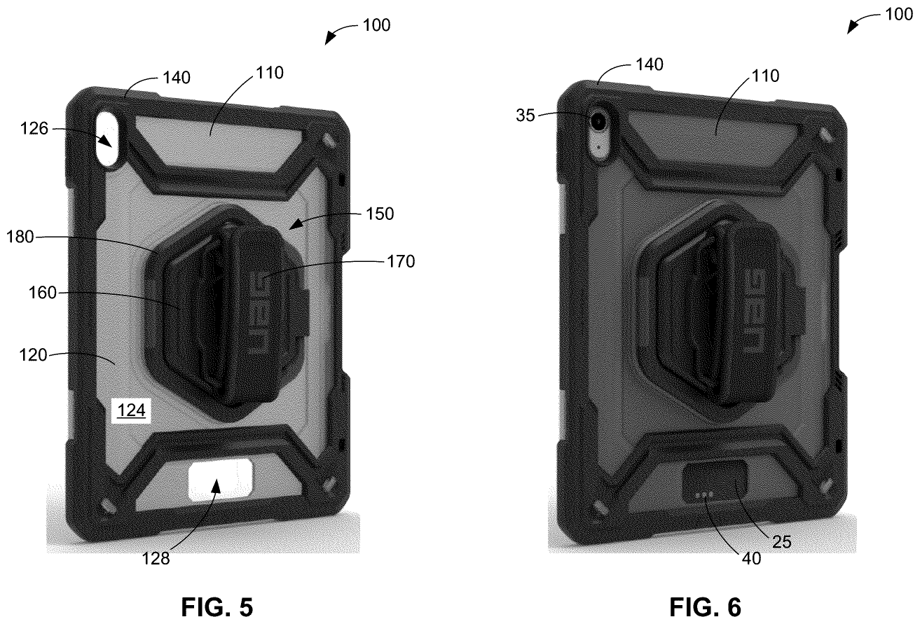

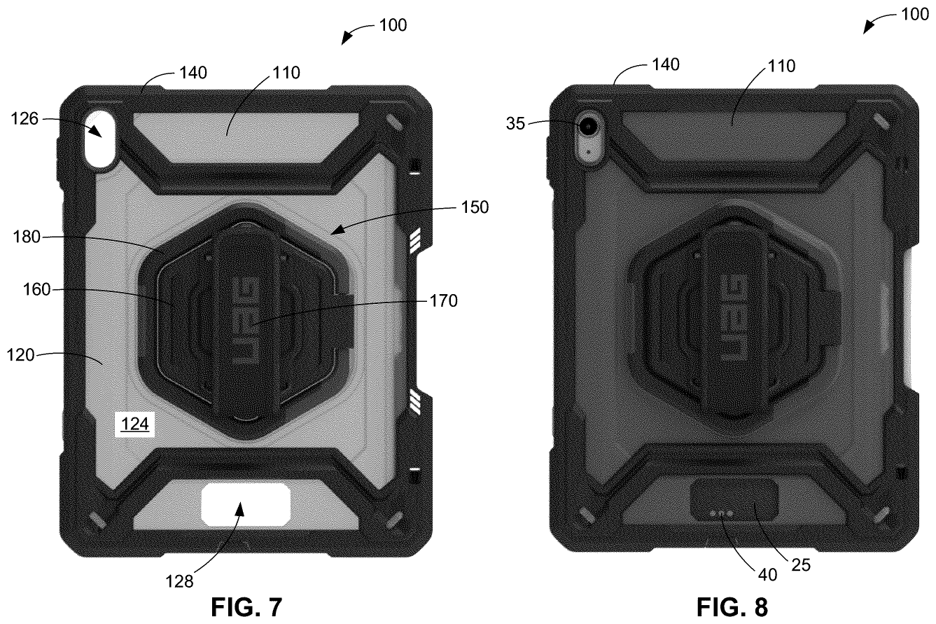

The case 100 (also referred to as a “tablet case”) includes a body 110. As shown in FIGS. 1-4, the body 110 (also referred to as a “first body”) defines an opening 105 in which a tablet 25 is securely housed. For example, the body 110 includes a back wall 120 and a plurality of a side walls 130. The back wall 120 includes a front side 122 and a back side 124 (FIGS. 5 and 7).

The front side 122 of the back wall 120 and the side walls 130 define the opening 105 in which the tablet 25 is secured. The body 110 is configured to cover the sides and back of the tablet 25 to protect the tablet 25 from the environment. The back wall 120 defines a hole 126 and another hole 128. As shown in FIGS. 6 and 8, the hole 126 (also referred to as a “camera hole”) is for a camera 35 of the tablet 25 and the hole 128 (also referred to as an “audio hole”) is for audio device(s) 40, such as a speaker and/or microphone, of the tablet 25.

The case 100 of the illustrated example also includes a reinforcing body 140. As shown in FIGS. 1-4, the reinforcing body 140 (also referred to as a “second body”) extends along and covers the side walls 130 to provide structural support to the side walls 130 of the body 110. As shown in FIGS. 5-8, the reinforcing body 140 also extends along and covers portions of the back side 124 of the back wall 120 to provide structural support to the back wall 120. That is, the reinforcing body 140 is configured to provide structural support to the body 110. For example, the body 110 is formed of a relatively flexible material to facilitate a user in inserting the tablet 25 into and removing the tablet 25 from the opening 105 of the case 100. The reinforcing body 140 is formed of a relatively rugged material to (1) further securely retain the tablet 25 in the opening 105 of the case 100, (2) limit any deflection and/or deformation of the body 110 over time, and/or (3) to further protect the tablet 25 from the environment. In some examples, the body 110 and the reinforcing body 140 are co-molded together.

Returning to FIGS. 1-4, the case 100 defines a slot 145 to securely retain a pen 30 for the tablet 25. The slot 145 extends along and is adjacent to a side of the opening 105 for the tablet 25. In the illustrated example, the reinforcing body 140 defines the slot 145 for the pen 30. In other examples, the body 110 defines the slot 145. In yet other examples, the body 110 and the reinforcing body 140 combine to define the slot 145 such that the body 110 defines a portion of the slot 145 and the reinforcing body 140 defines another portion of the slot 145.

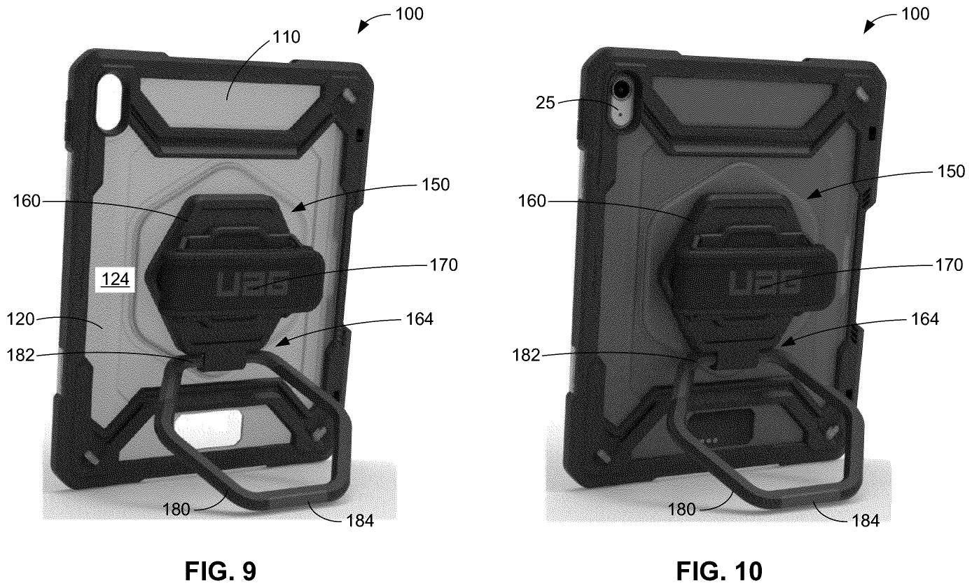

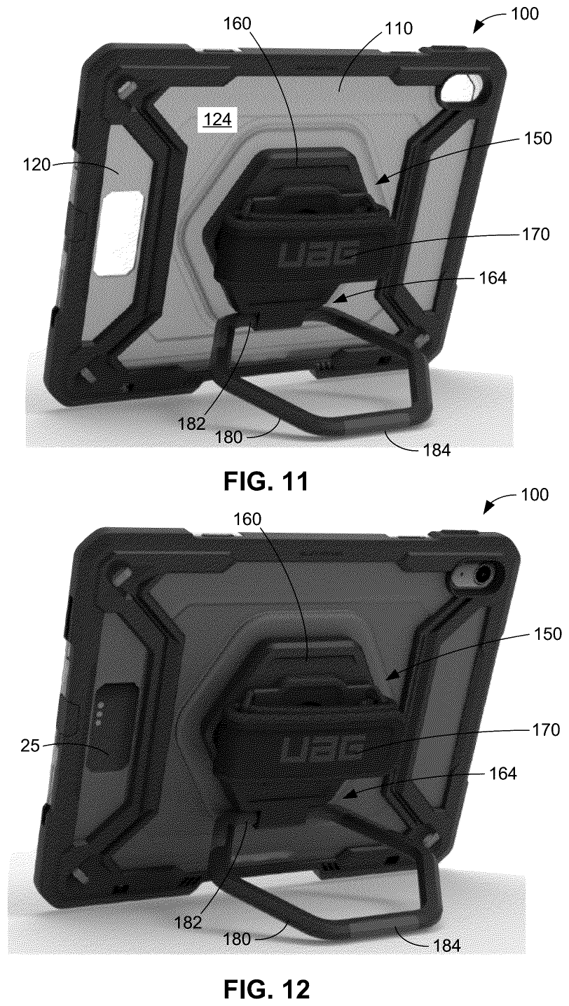

Turning to FIGS. 5-12, the case 100 also includes a stand 150 that is configured to prop up the case 100 and, in turn, the tablet 25 in a portrait orientation (FIGS. 9-10) and a landscape configuration (FIGS. 11-12).

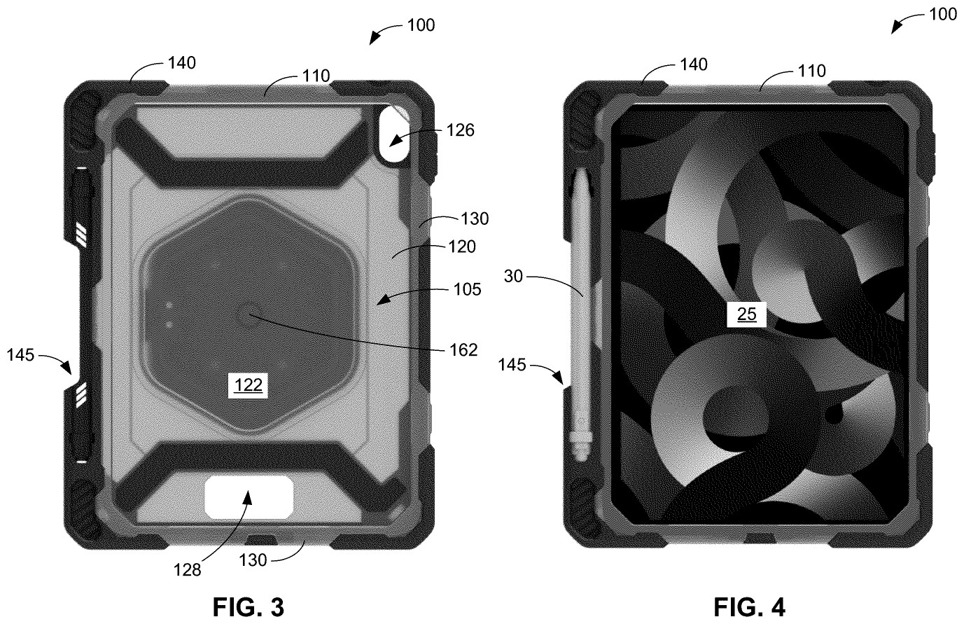

The stand 150 includes a base 160. In the illustrated example, the base 160 is rotatably coupled to the back side 124 of the back wall 120 of the body 110. In other examples, the base 160 may be rotatably coupled to the reinforcing body 140. Returning briefly to FIGS. 1 and 3, the base 160 is rotatably coupled to the back wall 120 of the body 110 via a rotatable fastener 162, such as a pin. The base 160 is configured to rotate (e.g., ninety degrees) relative to the body 110 about an axis (also referred to as a “first axis”) between the portrait orientation (FIGS. 9-10) and the landscape configuration (FIGS. 11-12). In the illustrated example, the axis extends through a center point of the back wall 120 in a direction perpendicular to a plane along which the back wall 120 extends.

Returning to FIGS. 5-12, the stand 150 of the illustrated example includes a hand strap 170. The hand strap 170 is configured to receive a hand of a user to facilitate the user in easily holding the case 100 and the tablet 25. The hand strap 170 is coupled to the base 160, for example, to position the hand strap 170 in a central location and/or enable the orientation of the hand strap 170 to be adjusted to facilitate the user in easily accessing the hand strap 170. The size of the hand strap 170 may be adjustable. For example, the hand strap 170 includes hook-and-loop fasteners and/or other mechanism(s) to adjust its size.

The stand 150 also includes one or more legs 180. The leg(s) 180 are hingedly coupled to the base 160 and are configured to rotate relative to the base 160 about a second axis. In the illustrated example, the second axis extends parallel to the plane along which the back wall 120 extends such that second axis about which the leg(s) 180 rotate is perpendicular to the first axis about which the base 160 rotates. The leg(s) 180 are configured to rotate between a closed position for a collapsed configuration of the stand 150 (FIGS. 5-8), a first extended position for a portrait configuration of the stand 150 (FIGS. 9-10), and a second extended position for a landscape configuration of the stand 150 (FIGS. 11-12).

In the collapsed configuration shown in FIGS. 5-8, the leg(s) 180 are in the closed position. The leg(s) 180 are configured to be nested with the base 160 in the collapsed configuration. The leg(s) 180 and the base 160 extend along the same plane when nested together. In the illustrated example, the leg(s) 180 surround at least a portion of the base 160 such that the base 160 is nested in and concentric with the leg(s) 180. The leg(s) 180 nest concentrically with the base 160 to create a compact profile of the case 100 when the stand 150 is not being used. The compact profile of case 100 may facilitate a user in (1) holding the case 100 and the tablet 25 in a handheld manner and (2) easily stowing away the case 100 and the tablet 25 when not in use.

In the portrait configuration shown in FIGS. 9-10, the leg(s) 180 are rotated to the first extended position to support the case 100 and/or the tablet 25 in the portrait orientation.

The leg(s) 180 include a proximal end 182 and a distal end 184. The proximal end 182 is coupled to the base 160 via a hinge 164. The distal end 184 is configured to engage a surface to support the portrait configuration and the landscape configuration. In some examples, the distal end 184 is composed of a material with a high coefficient of friction (e.g., rubber) to prevent the stand 150 from slipping when the distal end 184 of the leg(s) 180 engage the surface. Additionally or alternatively, the proximal end 182 may be composed of a material with a high coefficient of friction to temporarily fix the leg(s) in the first extended position while the case 100 rests in the portrait configuration or the landscape configuration.

In the landscape configuration shown in FIGS. 11-12, the leg(s) 180 are rotated to the first extended position to support the case 100 and/or the tablet 25 in the landscape orientation configuration.

To transition the stand 150 between the portrait configuration and the landscape configuration, (1) the base 160 is configured to rotate 90 degrees relative to the body 110 and (2) the leg(s) 180 are configured to rotate between the first extended position and the second extended position. The first extended position may correspond with a different degree-of-rotation relative to the base 160 compared to that of the second extended position to enable the case 100 and the tablet 25 to be oriented at different angles for the portrait configuration and the landscape configuration, respectively.

As shown in FIGS. 5-12, both the leg(s) 180 and the base 160 have a polygonal shape. More specifically, both the leg(s) 180 and the base 160 have a hexagonal shape. The polygonal shape of the leg(s) 180 matches that of the base 160 to enable the leg(s) 180 and the base 160 to be nested concentrically together in the collapsed configuration. In the illustrated example, the base 160 is smaller than the leg(s) 180 to enable the base 160 to be nested in the leg(s) 180 when the leg(s) 180 are in the closed position for the collapsed configuration.

In the illustrated example, the hinge 164 extends along one edge of the polygon shape of the base 160. Further, the leg(s) 180 of the illustrated example is a single polygonal-shaped leg. The leg 180 rotates about the hinge 164 extending along the edge of the base 160 such that the leg 180 fully encloses and nests concentrically with the base 160 in the collapsed configuration. In other examples, the leg(s) 180 may include two opposing legs that form a portion of a polygon and partially enclose the base 160 in the collapsed configuration.

As shown in FIGS. 9-12, the base 160, the leg(s) 180, and the hand strap 170 are arranged to prevent the leg(s) 180 from interfering a user from accessing the hand strap 170 when the leg(s) are in an extended position. The leg(s) are coupled to an edge of the base 160 via the hinge 164. The hand strap 170 is spaced apart from the edge along which the hinge 164 extends. Additionally, the base 160 is configured to be rotated such that the edge of the base 160 along which the hinge 164 extends is to be positioned toward the surface on which the leg(s) 180 stand. That is, in both the portrait configuration and the landscape configuration, the leg(s) 180 are positioned between the hand strap 170 and the surface and extend away from the hand strap 170 such that the leg(s) do not extend over and cover the hand strap 170.

Further, in the illustrated example, the polygonal shape of the base 160 has an even number of sides to guide a user in rotating the base 160 between the portrait configuration and the landscape configuration. For example, the edge of the base 160 along which the hinge 164 extends is to be positioned to be parallel to a short edge of the case 100 in the portrait configuration. That same edge is to be positioned to be parallel to a long edge of the case 100 in the landscape configuration. In turn, at least one edge of the polygon shape of the base 160 provides a visual cue that facilitates a user in orienting the hinge 164 of the base 160 relative the edges of the case 100 for the portrait configuration and the landscape configuration. At the same time, the distal end 184 of the even-sided polygon of the leg 180 is then able to align with a surface on which it rests to securely prop up the tablet 25 in the landscape configuration and/or the portrait configuration.

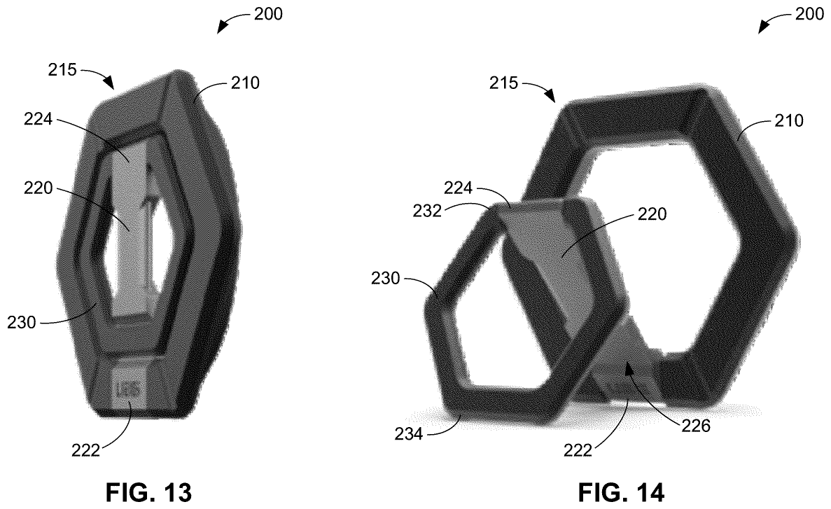

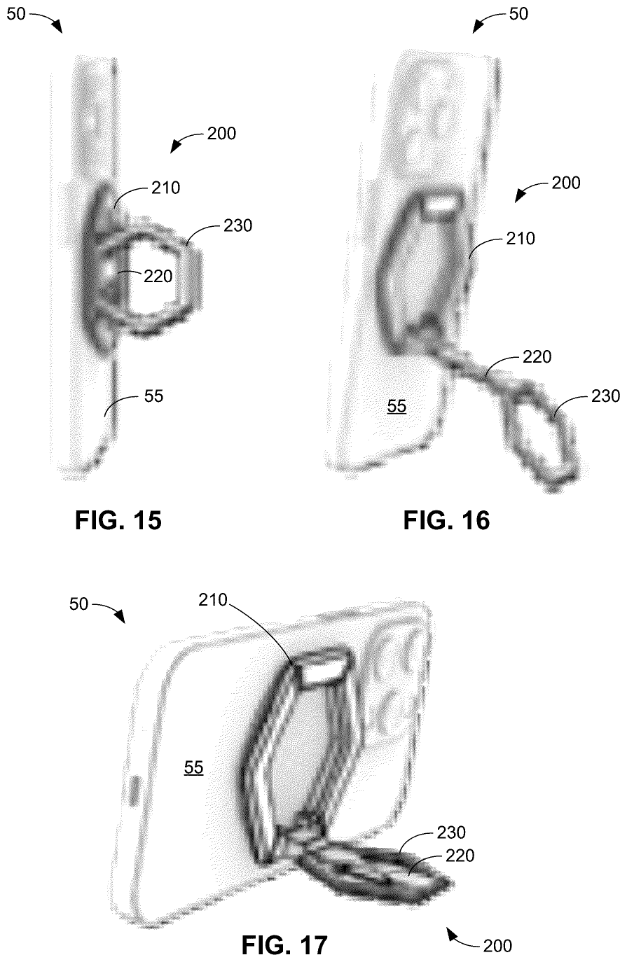

Turning to FIGS. 13-17, an example stand 200 for a smartphone 50 and/or other mobile device is depicted in accordance with the teachings herein. The stand 200 includes a base 210, a leg 220, and a foot 230. The leg 220 is configured to rotate about a first axis and the foot 230 is configured to rotate about a second axis to transition the stand 200 between a collapsed configuration (FIGS. 13-14), a ring-grip configuration (FIG. 15), a portrait configuration (FIG. 16), and a landscape configuration (FIG. 17).

As shown in FIGS. 15-17, the base 210 is configured to be adjustably coupled to a back side 55 of the smartphone 50. For example, the base 210 is configured to be rotated to a first orientation for the ring-grip configuration and the landscape configuration and to a second orientation for the portrait configuration. The first orientation is perpendicular to the second orientation.

Returning to FIGS. 13-14, the base 210 includes a magnet 215 to adjustably couple the base 210 to the back side 55 of the smartphone 50.

The leg 220 has a proximal end 222 (also referred to as a “proximal leg end”) and a distal end 224 (also referred to as a “distal leg end”). The proximal end 222 is hingedly coupled to the base 210. The leg 220 is configured to rotate about the first axis that extends along the hinged connection of the base 210 and the leg 220 (also referred to as a “first hinged connection”). In some examples, a portion of the base 210 and/or the proximal end 222 of the leg 220 is composed of a material with a high coefficient of friction (e.g., rubber) to temporarily fix the leg 220 in place when a user has positioned the leg 220 in an extended position for the portrait configuration and/or the landscape configuration.

The foot 230 has a proximal side 232 (also referred to as a “proximal foot side”) and a distal side 234 (also referred to as a “distal foot side”). The proximal side 232 is hingedly coupled to the distal end 224 of the leg 220. The foot 230 is configured to rotate about the hinged connection between the foot 230 and the leg 220 (also referred to as a “second hinged connection”). The second axis about which the foot 230 rotates relative to the leg 220 is parallel to the first axis about which the leg 220 rotates relative to the base 210. In some examples, the proximal side 232 of the foot 230 and/or the distal end 224 of the leg 220 is composed of a material with a high coefficient of friction (e.g., rubber) to temporarily fix the foot 230 in place relative to the leg 220 when the user has positioned the foot 230 in an extended position for the ring-grip configuration and/or the portrait configuration. Additionally or alternatively, the distal side 234 may be composed of a material with a high coefficient of friction to prevent the stand 200 from slipping when the distal side 234 of the foot 230 engages a surface.

In the collapsed configuration of FIGS. 13-14, the leg 220 and the foot 230 are nested together in the base 210. The base 210, the leg 220, and the feet 230 extend along the same plane when nested together. The base 210, the leg 220, and the foot 230 nest together in the collapsed configuration to create a compact profile of the stand 200 when the stand 200 is not being used. In the illustrated example, the foot 230 is concentric with the base 210 when nested together. The compact profile may facilitate a user in easily stowing the smartphone 50 away when not in use.

In the illustrated example, the leg 220 defines a groove 226 that is configured to receive a portion (e.g., the distal side 234) of the foot 230 to enable the foot 230 to be nested with the leg 220 in the collapsed configuration. As shown in FIG. 14, the groove 26 is adjacent to the proximal end 222 of the leg 220 and extends parallel to the hinged connection between the leg 220 and the base 210.

In the ring-grip configuration of FIG. 15, the leg 220 is nested with the base 210 and the foot 230 is rotated to a first extended foot position relative to the leg 220. The leg 220 remains nested with the base 210 so that the leg 220 does not prevent a user from extending one or more fingers through the foot 230 to grip the foot 230 as a ring in the ring-grip configuration.

In the landscape configuration of FIG. 17, the foot 230 is nested with the leg 220 and the leg 220 is rotated to a first extended leg position relative to the base 210. For example, the leg 220 remains nested with the foot 230 in the landscape configuration so that both the foot 230 and the leg 220 rest on a surface to further support the smartphone 50 in a landscape orientation.

In the portrait configuration of FIG. 16, the leg 220 is rotated to an extended leg position relative to the base 210 and the foot 230 is rotated to an extended foot position relative to the leg 220. More specifically, the leg 220 is rotated to a second extended leg position, and the foot 230 is rotated to a second extended foot position. Both the leg 220 and the foot 230 are extended to enable the foot 230 to extend to a surface when the smartphone 50 is in a portrait orientation.

In some examples, the first extended foot position corresponds with a different degree-of-rotation of the foot 230 relative to the leg 220 compared to that of the second extended foot position to arrange the stand 200 in the ring-grip configuration and the portrait configuration, respectively. The first extended leg position may correspond with a different degree-of-rotation of the leg 220 relative to the base 210 compared to that of the second extended leg position to arrange the stand 200 in the portrait configuration and the landscape configuration, respectively.

In the illustrated example, both the foot 230 and the base 210 have a polygonal shape. More specifically, both the foot 230 and the base 210 have a hexagonal shape. The hinged connection between the leg 220 and the base 210 extends along an edge of the polygon shape of the base 210, and the hinged connection between the foot 230 and the leg 220 extends along an edge of the polygon shape of the foot 230. The polygonal shape of the foot 230 matches that of the base 210 to enable the foot 230 and the base 210, along with the leg 220, to be nested together in the collapsed configuration. In the illustrated example, the foot 230 is smaller than the base 210 to enable the foot 230, along with the leg 220, to be nested in the base 210 for the collapsed configuration. Further, in some examples, the base 210 may have an open, partially-polygonal shape such that the foot 230 and the leg 220 are partially nested in the base 210 in the collapsed configuration. Additionally or alternatively, the stand 200 may include two opposing feet that form a portion of a polygon.

Further, in the illustrated example, the polygonal shape of the base 210 has an even number of sides to guide a user in rotating the base 210 between (1) the first orientation for the ring-grip configuration and the landscape configuration and (2) the perpendicular second orientation for the portrait configuration. For example, the edge of the base 210 along which the hinged connection with the leg 220 extends is to be positioned to be parallel to a long edge of the smartphone 50 in the ring-grip configuration and the landscape configuration. That same edge is to be positioned to be parallel to a short edge of the smartphone 50 in the portrait configuration. In turn, at least one edge of the polygon shape of the base 210 provides a visual cue that facilitates a user in orienting the base 210 relative the edges of the smartphone 50 for the ring-grip configuration, the portrait configuration, and the landscape configuration. At the same time, the distal side 234 of the even-sided polygon of the foot 230 is then able to align with a surface on which it rests to securely prop up the smartphone 50 in the landscape configuration and/or the portrait configuration.

Exemplary embodiments in accordance with the teachings herein are disclosed below.

An example tablet case includes a body including a back wall and a plurality of a side walls. The back wall includes a front side and a back side. The front side of the back wall and the plurality of side walls define an opening in which a tablet is configured to be securely housed. The tablet case includes a stand. The stand includes a base rotatably coupled to the back side of the back wall about a first axis. The stand includes one or more legs hingedly coupled to the base and configured to rotate about a second axis between a closed position, a first extended position, and a second extended position. The one or more legs are configured to be nested with the base in a collapsed configuration when the one or more legs are in the closed position. The one or more legs are configured to support the body in a portrait configuration when the one or more legs are in the first extended position. The one or more legs are configured to support the body in a landscape configuration when the one or more legs are in the second extended position.

In some examples, each of the one or more legs and the base has a polygonal shape to enable the base to nest with the one or more legs. In some such examples, the polygonal shape is a hexagon.

In some examples, the one or more legs of the stand has an even-sided polygonal shape with a proximal side being hingedly coupled to the base and an opposing distal side configured to securely engage a surface in the portrait configuration and the landscape configuration.

In some examples, in the collapsed configuration, the one or more legs are configured to surround the base such that the base is nested in the one or more legs.

In some examples, the first axis about which the base of the stand rotates relative to the body is perpendicular to the second axis about which the one or more legs rotate relative to the base.

In some examples, the first extended position of the one or more legs corresponds with a different degree-of-rotation about the second axis than that of the second extended position.

In some examples, the base of the stand is configured to rotate ninety degrees relative to the body to transition between the portrait configuration and the landscape configuration.

Some examples further include a hand strap coupled to the base of the stand. In some such examples, to prevent the one or more legs from interfering with access to the hand strap, the one or more legs are hingedly coupled to an edge of the base; the hand strap is spaced apart from the edge; and the one or more legs extends away from the hand strap in the first extended position and the second extended position.

An example stand for a mobile device includes a base configured to be adjustably coupled to a back side of the mobile device. The stand includes a leg having a proximal end and a distal end. The proximal end is hingedly coupled to the base and configured to rotate about a first axis. The stand includes a foot hingedly coupled to the distal end of the leg and configured to rotate about a second axis. The leg is configured to rotate about the first axis and the foot is configured to rotate about the second axis to transition the stand between a collapsed configuration, a ring-grip configuration, a portrait configuration, and a landscape configuration. The base, the leg, and the foot are configured to nest together in the collapsed configuration.

In some examples, the foot has a shape that matches with that of the base to enable the foot to nest with the base in the collapsed configuration.

In some examples, each of the base and the foot has a polygonal shape. In some such examples, the polygonal shape is a hexagon. In some such examples, the polygonal shape is even-sided such that the foot has a proximal side hingedly coupled to the base and an opposing distal side configured to securely engage a surface in the portrait configuration and the landscape configuration.

In some examples, in the collapsed configuration, the leg and the foot are nested in the base. In some such examples, the leg defines a groove that is configured to receive a portion of the foot to enable the foot to be nested with the leg in the collapsed configuration.

In some examples, the first axis about which the leg rotates relative to the base is parallel to the second axis about which the foot rotates relative to the leg.

In some examples, the proximal end of the leg is hingedly coupled to a first edge of the base and the distal end of the leg is hingedly coupled to a second edge of the foot.

In some examples, the base includes a magnet to adjustably couple the base to the back side of the mobile device.

In some examples, in the ring-grip configuration, the leg is nested with the base and the foot is rotated to an extended foot position relative to the leg.

In some examples, in the landscape configuration, the foot is nested with the leg and the leg is rotated to an extended leg position relative to the base.

In some examples, in the portrait configuration, the leg is rotated to an extended leg position relative to the base and the foot to an extend foot position relative to the leg.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A tablet case, comprising:
a body including a back wall and a plurality of a side walls, wherein the back wall includes a front side and a back side, and wherein the front side of the back wall and the plurality of side walls define an opening in which a tablet is configured to be securely housed; and
a stand comprising:
a base rotatably coupled to the back side of the back wall about a first axis; and
one or more legs hingedly coupled to the base and configured to rotate about a second axis between a closed position, a first extended position, and a second extended position, wherein the one or more legs are configured to be nested with the base in a collapsed configuration when the one or more legs are in the closed position, wherein the one or more legs are configured to support the body in a portrait configuration when the one or more legs are in the first extended position, and wherein the one or more legs are configured to support the body in a landscape configuration when the one or more legs are in the second extended position.

2. The tablet case of claim 1, wherein each of the one or more legs and the base has a polygonal shape to enable the base to nest with the one or more legs.

3. The tablet case of claim 2, wherein the polygonal shape is a hexagon.

4. The tablet case of claim 1, wherein the one or more legs of the stand has an even-sided polygonal shape with a proximal side being hingedly coupled to the base and an opposing distal side configured to securely engage a surface in the portrait configuration and the landscape configuration.

5. The tablet case of claim 1, wherein, in the collapsed configuration, the one or more legs are configured to surround the base such that the base is nested in the one or more legs.

6. The tablet case of claim 1, wherein the first axis about which the base of the stand rotates relative to the body is perpendicular to the second axis about which the one or more legs rotate relative to the base.

7. The tablet case of claim 1, wherein the first extended position of the one or more legs corresponds with a different degree-of-rotation about the second axis than that of the second extended position.

8. The tablet case of claim 1, wherein the base of the stand is configured to rotate ninety degrees relative to the body to transition between the portrait configuration and the landscape configuration.

9. The tablet case of claim 1, further comprising a hand strap coupled to the base of the stand.

10. The tablet case of claim 9, wherein, to prevent the one or more legs from interfering with access to the hand strap:
the one or more legs are hingedly coupled to an edge of the base;
the hand strap is spaced apart from the edge; and
the one or more legs extends away from the hand strap in the first extended position and the second extended position.

11. A stand for a mobile device, the stand comprising:
a base configured to be adjustably coupled to a back side of the mobile device;
a leg having a proximal end and a distal end, wherein the proximal end is hingedly coupled to the base and configured to rotate about a first axis;
a foot hingedly coupled to the distal end of the leg and configured to rotate about a second axis,
wherein the leg is configured to rotate about the first axis and the foot is configured to rotate about the second axis to transition the stand between a collapsed configuration, a ring-grip configuration, a portrait configuration, and a landscape configuration, and
wherein the base, the leg, and the foot are configured to nest together in the collapsed configuration.

12. The stand of claim 11, wherein the foot has a shape that matches with that of the base to enable the foot to nest with the base in the collapsed configuration.

13. The stand of claim 11, wherein each of the base and the foot has a polygonal shape.

14. The stand of claim 13, wherein the polygonal shape is a hexagon.

15. The stand of claim 13, wherein the polygonal shape is even-sided such that the foot has a proximal side hingedly coupled to the base and an opposing distal side configured to securely engage a surface in the portrait configuration and the landscape configuration.

16. The stand of claim 11, wherein, in the collapsed configuration, the leg and the foot are nested in the base.

17. The stand of claim 16, wherein the leg defines a groove that is configured to receive a portion of the foot to enable the foot to be nested with the leg in the collapsed configuration.

18. The stand of claim 11, wherein the first axis about which the leg rotates relative to the base is parallel to the second axis about which the foot rotates relative to the leg.

19. The stand of claim 11, wherein the proximal end of the leg is hingedly coupled to a first edge of the base and the distal end of the leg is hingedly coupled to a second edge of the foot.

20. The stand of claim 11, wherein the base includes a magnet to adjustably couple the base to the back side of the mobile device.

21. The stand of claim 11, wherein, in the ring-grip configuration, the leg is nested with the base and the foot is rotated to an extended foot position relative to the leg.

22. The stand of claim 11, wherein, in the landscape configuration, the foot is nested with the leg and the leg is rotated to an extended leg position relative to the base.

23. The stand of claim 11, wherein, in the portrait configuration, the leg is rotated to an extended leg position relative to the base and the foot to an extend foot position relative to the leg.
